(19) United States
(12) Patent Application Publication
(10) Pub. No.: US 2020/0055176 A1
(43) Pub. Date: Feb. 20, 2020

(54) ATTACHMENT FOR A DRILL

(71) Applicant: Donald Butler Curchod, Avalon NSW (AU)

(72) Inventor: Donald Butler Curchod, Avalon NSW (AU)

(21) Appl. No.: 16/546,091

(22) Filed: Aug. 20, 2019

Related U.S. Application Data
(60) Provisional application No. 62/842,996, filed on May 3, 2019.
(60) Provisional application No. 62/719,892, filed on Aug. 20, 2018.

(51) Int. Cl. B25F 5/02; B25B 21/00

(52) U.S. Cl. CPC B25F 5/029; B25B 21/007

(57) ABSTRACT

An apparatus is described that permits attaching, via a holder or container, one or more pieces, e.g., drill and/or driver bits, to a drill. Such attachment makes it possible to transport drill and/or driver bits or other drill pieces with the drill, preventing the need to search within a toolbox or cabinet for the particular drill bit needed to satisfy drilling and/or driving requirements.

### CROSS-REFERENCE TO RELATED APPLICATIONS

The present application claims priority to U.S. Patent Application No. 62/719,892, filed Aug. 20, 2018, entitled ATTACHMENT FOR A DRILL, and U.S. Patent Application No. 62/842,996, filed May 3, 2019, entitled ATTACHMENT FOR A DRILL, the disclosure of which are incorporated herein by reference in their entirety.

### TECHNICAL FIELD

The subject matter described herein relates generally to attaching, via a holder or container, drill and/or driver bits, or other drill pieces, to a cordless drill or driver.

### BACKGROUND

When there is a need for a new drilling or driving operation, a user (e.g., a tradesman or a handyman) needs to first search for a desirable or necessary drill bit or other drill or driver piece. This may require searching through a toolbox or cabinet. Such searching can consume an undesirable amount of time and effort.

### SUMMARY

Systems, methods, and articles of manufacture are provided for attaching, via a holder or container, one or more pieces—e.g., drill and/or driver bits—to a drill. Such attachment makes it possible to transport drill and/or driver bits or other drill pieces with the drill, preventing the need to search within a toolbox or cabinet for the particular drill bit needed to satisfy drilling or driving requirements.

In one aspect, there is a system that includes a container to store at least one of one or more drill and/or driver bits. The system further includes an attachment mechanism adapted to connect the container to a drill, the connection enabling access to at least one of the one or more drill and/or driver bits.

In optional variations one or more additional features, including but not limited to the following, can be included in any feasible combination. For example, the system may include another container. For example, the system may include more than one other container. The container may include a drill bit pouch. The container may include a drawer. The attachment mechanism may be adapted to connect the container to a side of the drill. The attachment mechanism may be adapted to connect the container to a bottom of the drill. The drill may include a handle. The attachment mechanism may be adapted to connect the container to the handle. The drill may include a drill barrel. The attachment mechanism may be adapted to connect the container to the drill barrel. The attachment mechanism may include hook attachments for engagement of a loop strip. The attachment mechanism may include at least one hook and loop strip. The attachment mechanism may include a holder strip configured to wrap around at least a portion of at least one of the container and the drill. The container may include a cam lock. The attachment mechanism may include a tongue and a groove. The tongue and the groove may be configured to interlock. The attachment mechanism may include a bracket. The container may be attached to a battery. The attachment mechanism may be adapted to connect the container to the battery. The attachment mechanism may include a holder strip configured to wrap around at least a portion of the battery.

The details of one or more variations of the subject matter described herein are set forth in the accompanying drawings and the description below. Other features and advantages of the subject matter described herein will be apparent from the description, the drawings, and the claims.

### DESCRIPTION OF THE DRAWINGS

The accompanying drawings, which are incorporated in and constitute a part of this specification, show certain aspects of the subject matter disclosed herein and, together with the description, help explain some of the principles associated with the subject matter disclosed herein. In the drawings,

FIG. 1 illustrates an example of a cordless drill with a combination of holders with various assortments of drill and/or driver bits;

FIG. 2 illustrates an example of a cordless drill with a drill bit pouch attachment;

FIG. 3 illustrates an example of a cordless drill with a side container containing an assortment of dill bits;

FIG. 4 illustrates an example of a cordless drill with a side container containing an assortment of drill and/or driver bits;

FIG. 4A illustrates an example of a handle container for one or more drill and/or driver bits for attachment to the cordless drill of FIG. 4;

FIG. 5 illustrates an example of a side mounted container for housing drill and/or driver bits, for attachment to a drill, such as the cordless drill of FIG. 4;

FIG. 6 illustrates an example of a bottom container for housing drill and/or driver bits, the bottom container mounted on the bottom of a cordless drill;

FIG. 6A illustrates an example of a bottom container for housing drill and/or driver bits, the bottom container mounted on the bottom of a cordless drill;

FIG. 7 illustrates an example of a drill bit holder surrounding and mounted on the drill barrel of a cordless drill;

FIG. 8 illustrates an example of a drill bit holder surrounding and mounted on the drill barrel of a cordless drill;

FIG. 9 illustrates an example of a drill bit holder surrounding and mounted on the drill barrel of a cordless drill;

FIG. 10 illustrates an example of a cordless drill with a bottom container attached, as well as additional drill and/or bit holders attached;

FIG. 10A illustrates and example of a drill bit holder with molding and a bottom housing;

FIG. 10B illustrates an example of a cordless drill with an bottom drawer and an exterior side holder;

FIG. 11 illustrates an example of a cordless drill with an alternate bottom container;

FIG. 11A illustrates an example of a cordless drill with two bottom containers;

FIG. 11B illustrates a partial view of a cordless driver nose;

FIG. 12 illustrates an example of a cordless drill with a modified side container;

FIG. 12A illustrates an example of a cordless drill with a side holder assembly with covers;

FIG. 12B illustrates and example of a cordless drill being held by a tradesman or handyman;

FIG. 13 illustrates an example of a cordless drill with an alternative bottom container arrangement;

FIG. 13A illustrates a portion of a cordless drill with another bottom container arrangement;

FIG. 13B illustrates a cordless drill with another side container arrangement;

FIG. 14 illustrates a bottom portion of a cordless drill with an alternative arrangement of a bottom container.

When practical, similar reference numbers denote similar structures, features, or elements.

### DETAILED DESCRIPTION

The subject matter described herein describes an apparatus that permits attaching, via a holder or container, one or more pieces—e.g., drill and/or driver bits—to a drill. Such attachment advantageously enhances the functionality of a single drill while preventing the need to find different components to satisfy different work requirements. The technology disclosed herein applies to both drills and drivers. For clarity of presentation, many of the examples discussed in this application refer to drills, but apply equally to drivers.

The drill and/or driver bits can also be referred to as bits or drivers in some implementations. Drill and/or driver bits can include one or more of: driver bits, driving bits, twist drills, auger bits, brad-point drills, paddle bits, plug cutter, hinge cutter, metal bits, high-speed steel (“HSS”) drills, cobalt drills, black oxide-coated HSS drill and/or driver bits, titanium-coated HSS drills, carbide-tipped drills, self-feed bits, installer drill and/or driver bits, reduced shank HSS bits, pilot point bits, coring drills, countersink bits, drill bit extensions, Forstner bits, hole saw bits, installer bits, masonry drills, spade drills, specialty drill and/or driver bits, step drill bits, percussion bits, multi-purpose bits, glass and tile bits, hole-cutter bits, screwdriver bits, saw bits, wood drill bits, diamond bits, hole saw, pocket hole bits, scaling chisels, depth stops, screw or bolt extractors, right-angle attachments, and the like.

The drill described herein is described in some implementations as being a cordless drill. In other implementations, the drill can have a cord and thus be a corded drill. The drill can, in some implementations, be a rechargeable drill, power drill, drill-driver, hand drill, pistol-grip drill, hammer drill, magnetic drilling machine, rotary hammer drill, drill press, geared head drill press, impact driver, power screwdriver, corded drill, brace drill, electric drill, non-electric drill, pneumatic drill, air drill, impact drill, air wrench, screwdriver drill, combi drill, mechanic drill, hex drill, or any other type of drilling apparatus.

Cordless drills or drivers are used for both drilling and driving screws. Commonly a job requires both an efficient way of doing this is to employ 2 devices, one for drills and one for screw driving, but this requires 2 devices, which has obvious disadvantages. If only one device is used, then frequent changing of drills and/or bits is required which is time consuming and inconvenient. This is made convenient with a side-mounted holder outlined above, however the amount of storage for this concept is much less than an attached container also detailed above.

It is, a further advantage of this invention to provide a more efficient way of utilizing one drill/driver for multiple tasks requiring more than one drill or bit, in addition to the advances noted above, when an attached drill/bit container is attached. This entails, in a drill with an attached container for storing drills and/or bits plus a secondary quick access holder for storing the drills or bits, which are required for the particular job.

The inventions described herein avoid the frustrating time consuming, constant searching and accessing the drills or bits when changing from chuck to storage. During the job, the additional drill/bit holder allows the drills and bits required for the job to be initially selected and stored in the quick access holder rather than the container. In this way, these items are quickly and easily exchanged between the quick access holder and chuck on a particular job. Note the chuck can be a normal or a quick access chuck.

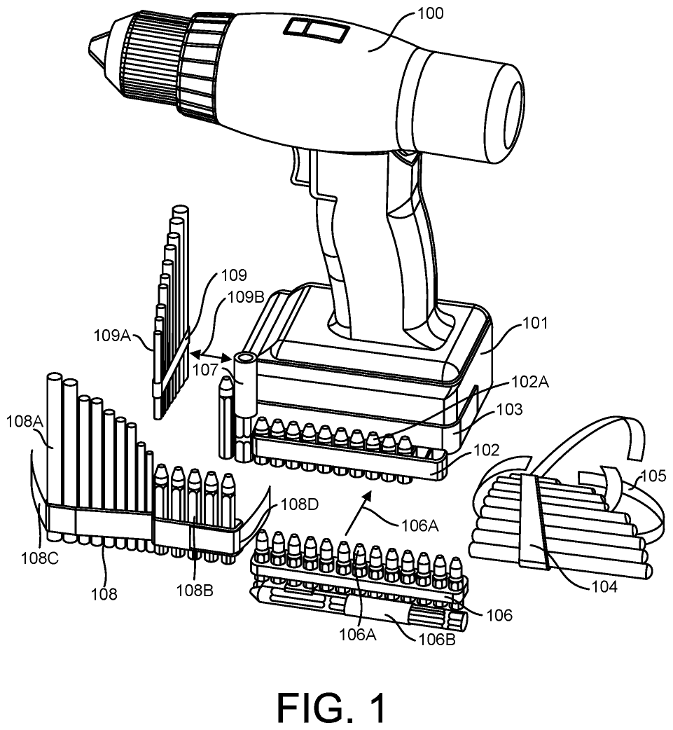

FIG. 1 illustrates a cordless drill 100 with battery 101 and drill bit holder 102 including slots for an assortment of drill and/or driver bits having bits 102A fitted to holder 102, including bit extension 107. Attached to battery 101 is loop fabric 103 (attached via one or more screws, adhesive, or any other fastening mechanism) to retain the holder 102. The holder 102 has a corresponding hook fabric attached to the backside, such that pressing the holder 102 on to the battery 101, as shown, causes hook and loop to engage and securely hold the holder assembly to the battery 101.

Also shown are assemblies 104, 106, 108 and 109, which are a series of other possible holder assemblies able to be attached to the battery 101 in a similar manner. The assembly 104 is a holder assembly with an assortment of horizontal drill bits. The assembly 106 is a holder assembly with an alternative series of driver bits 106A held in bit holder 106 together with bit holder extension 106B. Arrow 106A shows 106 attachment direction if used in place of assembly 102. The assembly 108 is a holder assembly with an assortment of drill and/or driver bits 108A and 108B.

Also shown are hook strips 108C and 108D, which are attached to the front of holder 108. These can be used instead of or in addition to a backside hook attached to the holder 108. These fabric hook strips loop around perpendicularly to holder 108, as shown, to make the attachment more secure.

The assembly 109 shows a holder assembly, with an assortment of vertical drill bits. The holders 104, 106, 108 and 109 all have hook attachments for engagement of loop 103. The assembly 109 is shown with hook attachment 110, which is designed to attach to the front of the battery 101. One simple method shown for attachment of holder assemblies is via hook and loop fabric strips. The loop fabric 103 and the hook attachment 110 can respectively be attached to the battery and to the mating side of the drill 100 or bit holder 102.

In an alternate implementation, the hook and loop can be plastic (as an alternative to fabric). The holder 104 can also show an alternate attachment method with hook and loop strips 105, attached to holder 104 strips 105 wrap around battery 101 to secure holder assembly 104. This attachment method can also be employed to any other holder assembly or container. Various attachments methods can be employed in place of the hook and loop shown to attach the holder assemblies or containers. Each of holders 104, 106, 108 and 109 can be readily attached to, or detached from, the battery 101 using hook and loop or an alternative attachment method.

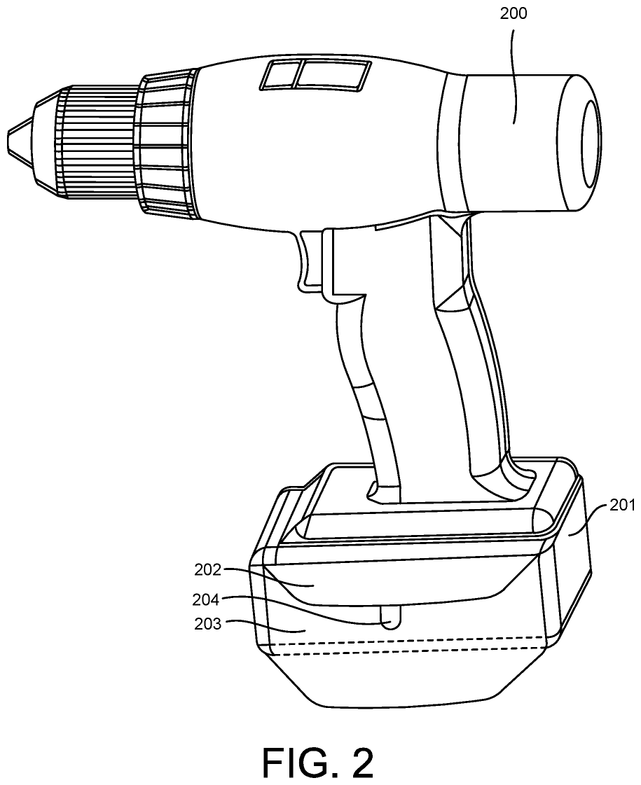

FIG. 2 illustrates a cordless drill 200 with side pouch 203 having lid 202 and closure 204, hook and loop. The pouch 203 can be attached via hook and loop, previously described, or any other fastening mechanism (such as tape, screws, snaps, buttons, zipper, magnets, hooks, ties, one-touch release mechanisms, or the like). Pouch lid 203 can open vertically so that an assortment of one or more drill and/or driver bits associated with the drill can be stored within. Pouch 203, which may be of fabric or molded material, can be attached to the battery 201 by any number of fastening mechanisms, such as a hook and loop. Such pouch 203 can be attached to any side end or bottom of the drill or battery. The pouch 203 can be readily attached to, or detached from, the battery 101 using hook and loop or an alternative attachment method.

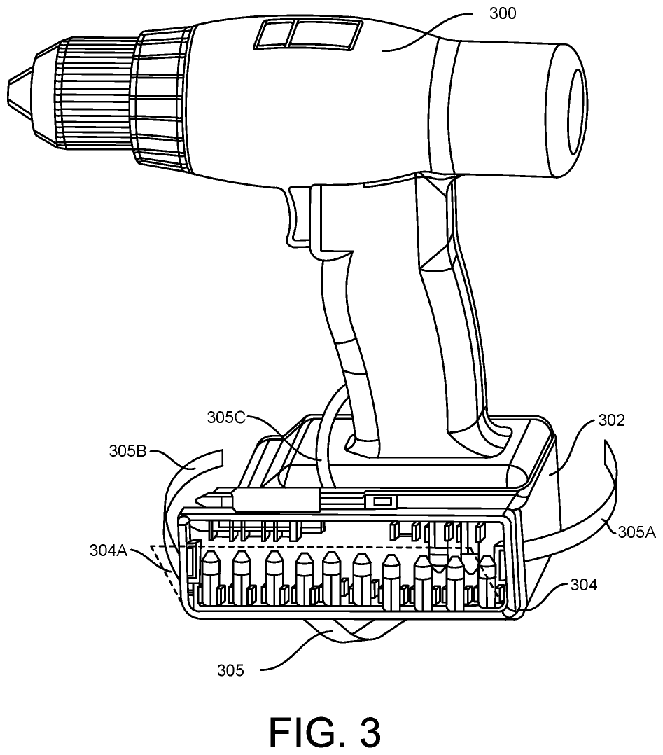

FIG. 3 illustrates a cordless drill 300 with battery 302. Attached to battery 302 is container 304 containing an assortment of drill and/or driver bits. As shown, drill and/or driver bits snap into the holder 304. While the container 304 is shown as being open, the container 304 can have a lid shown dotted at 304A or 304B. The container 304 shown is attached to the battery 302 via hook and loop fabric fastened to the battery 302 and container 304 respectively.

There can be an alternative attachment via fabric hook and loop, comprising strips 305, 305A, 305B and 305C, which can be wrapped around battery 302. Many alternate forms of attachment can be employed. The container 304 can be readily attached to, or detached from, the battery 101 using hook and loop or an alternative fastening mechanism. In various embodiments, one or more holders or containers are attached directly to the drill or driver, rather than the battery.

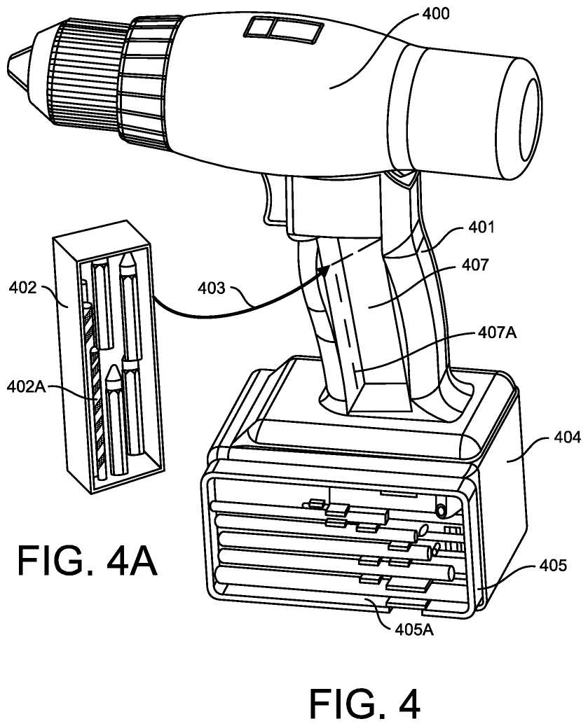

FIG. 4 illustrates a cordless drill 400 with a battery 404. The container 405 containing drill assortment 405A is attached to the battery 404 via hook and loop or other fastening mechanism. Also shown in FIG. 4 is recess 407 in the handle 401. The container 402 of FIG. 4A has an assortment of one or more drills and/or bits 402A. The container 402 is designed to snap into handle opening 407 so as to store one or more drill and/or driver bits within, as shown by arrow 403. In some implementations, methods to retain container 402 may be used. Alternatively, handle recess 407 could have a lid shown dotted at 407A, whereby one or more drill and/or driver bits could be stored within recess 407, without need of separate container 402.

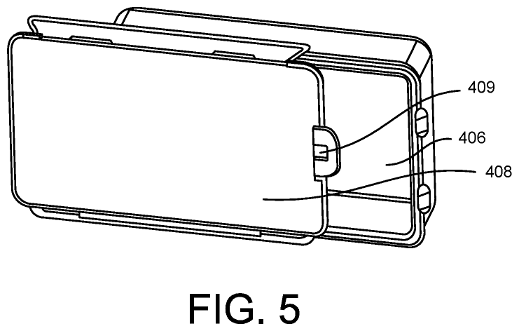

FIG. 5 illustrates a container 406, which is an alternative to the container 405. The alternative container 406 can hold a variety of one or more drill and/or driver bits. The container 406 has a sliding lid 408 and a closure tab 409. The container 406 may be used in place of, or in addition to, the container 405. The connection to the battery (or drill) can be quickly and readily made or broken.

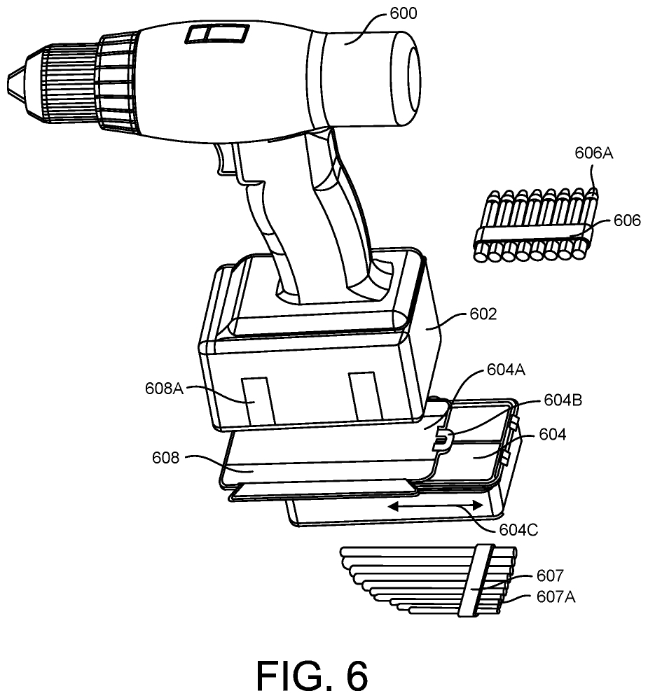

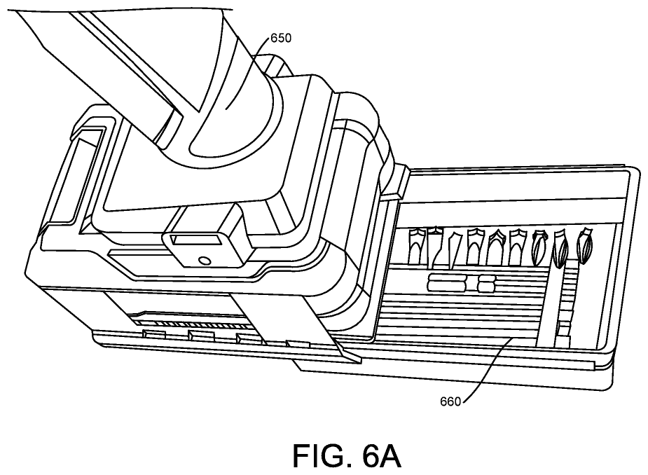

FIG. 6 illustrates a cordless drill 600 with the battery 602. The container 604 with the lid 604A is shown positioned below battery 602. The container 604 may be referred to as a bottom container since it attaches to the bottom of the battery 602. The hook and loop strips 608 and 608A are shown attached respectively to the battery 602 and lid 604A, such that secure attachment of lid 604A can be made to underside of battery 602. The container 604 slides in and out shown by arrow 604C. The container 604 is designed to carry assorted drill and/or driver bits. Shown is a drill assortment 607A in holder 607 and/or the bit assembly 606A in the holder 606.

FIG. 6A illustrates a bottom container 660 of the cordless drill 650. The bottom container 660 can hold drill and/or driver bits as well as screw bits. In one implementation, a first portion of the container 660 may be customized to hold drill and/or driver bits and the remaining portion may be customized to hold screws, nails, and/or the like. For example, the first portion may occupy approximately 25%, 50%, or 75% of the container 660, and the remaining portion may occupy a corresponding approximately 75%, 50%, and 25% of the container 660, respectively. Any other division of such space may be possible in different implementations.

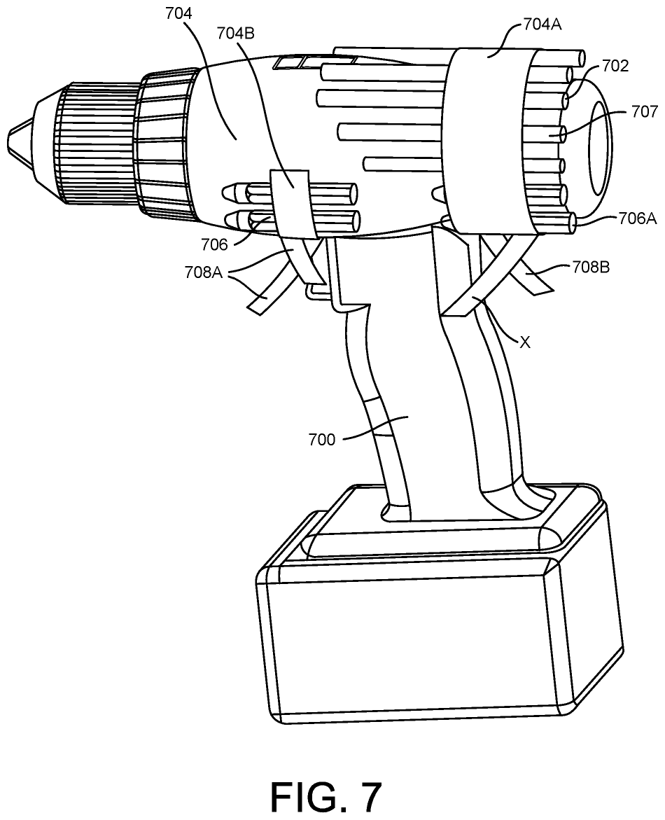

FIG. 7 illustrates a cordless drill 700 with one or more drill and/or driver bits. The container 704 is wrapped around barrel 702 of the drill 700. Various drill and/or driver bits are shown at 706, 706A and 707, which are captive in a container wrap 704 at 704A by overlap of 704A and 704B. The container wrap 704 may be fabric plastic or rubber etc. and can snap around the barrel 702. Alternatively, hook and loop wrap strips 708A and 708B can be used to secure the wrap 704.

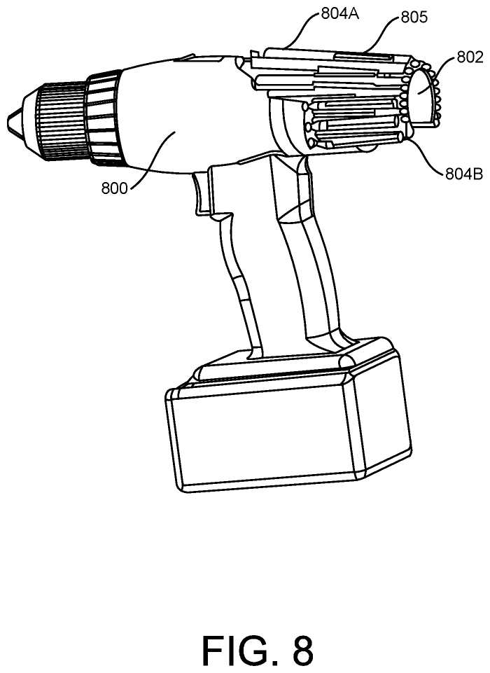

FIG. 8 illustrates cordless drill 800 with a molded (or fabric) drill and/or bit holder 802. The holder 802 includes drill and/or driver bits 804A and/or 804B retained by snapping into holder 802 typically at 805. The holder 802 can be fastened to the drill in any manner.

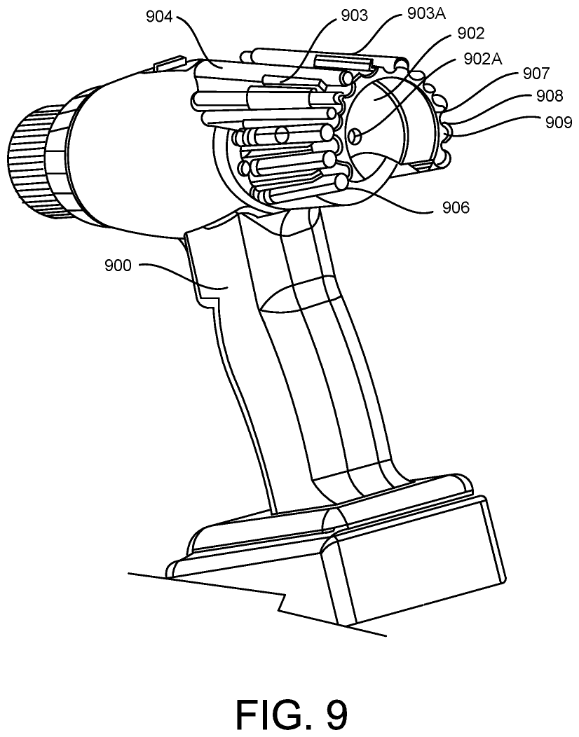

FIG. 9 illustrates cordless drill 900 with bit holder 902. The bit holder 902 can be similar to the holder 802 of FIG. 8. The bit holder 902 can be attached to the back of the drill 900 via a screw 902A. The housing 902 can have one or more drill and/or driver bits 904 and/or 906 held in slots or holes. A hole for retaining one or more drill and/or driver bits is shown at 903.

End of housing 902 has rotatable scalloped ring 907 such that one or more drill and/or driver bits 904 and/or 906 are retained by high points in a ring 907, one example of which high point is shown at 909. The one or more drill and/or driver bits 904 and/or 906 can be removed by rotating the ring 907 to a position that allows the one or more drill and/or driver bits to be removed through low points, one example of which is shown at 908.

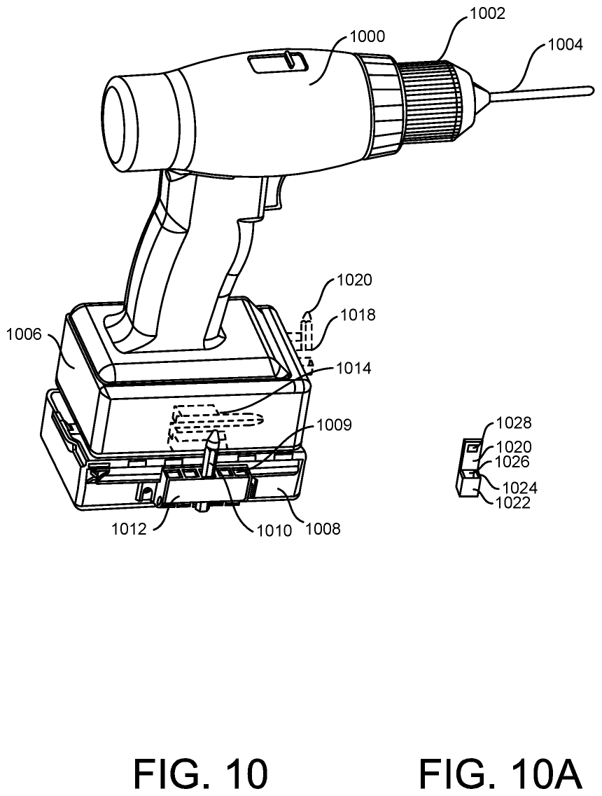

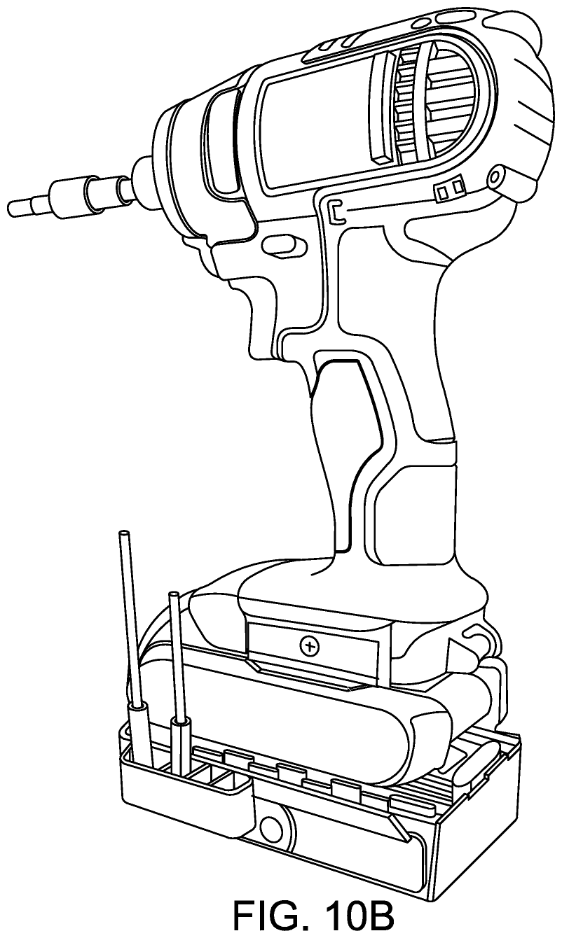

FIG. 10 illustrates a cordless drill 1000 with chuck 1002 holding drill bit 1004, and battery 1006. Attached to drill 1000 is container 1008, which may, for example, correspond to container 604 of FIG. 6. Container 1008 may hold drill and/or driver bits, drill bit extenders, screwdrivers, or other drill pieces. The additional drill and/or bit holder 1012, attached to the container 1008, includes quick access holes or slots 1009 for at least one drill and/or bit 1010. The quick access holes or slots may accommodate drill and/or driver bits, drill bit extenders, screwdrivers, or other drill pieces. The holes or slots of drill bit holder 1012 can be fixed in any position on the drill 1000. Drill bit holder 1012 may be permanently attached to the drill, or it may be removably attached using, for example, loop and hook.

When a user is employing more than one drill or bit at a time, it is simpler and quicker to have one drill or bit, as at 1004 held in the chuck 1002 and at least one other drill or bit held for quick deployment as shown at 1010 in a secondary drill and/or drill bit holder 1012. The system shown in FIG. 10 allows for more convenient, speedy access and use of multiple drill and/or driver bits or other drill pieces, without needing to go back to a toolbox or cabinet to locate another drill bit or drill piece, while employing one drill or driver for a task.

Drill bit holder 1012 is attached to container 1008, for holding drill and/or driver bits in a vertical position. Drill bit holder 1012, or a second drill bit holder 1014, may be attached to drill 1000, battery 1006, or container 1008 in other positions. For example, drill bit holder 1014 is mounted horizontally and on the side of the battery 1006. Moreover, drill bit holder 1012 and/or second drill bit holder 1014 may be constructed in any way to hold drills and/or bits. The holder could employ holes as shown for drill bit holder 1012, or snap in as shown for second drill bit holder 1014. Drill bit holder 1012 or secondary drill bit holder 1014 could also be magnetized in order to retain the drills and/or bits. Further alternate positions and types of holders with drills or bits are shown for third bit holder 1018, FIG. 10A shows a fourth bit holder 1020, which may be mounted permanently or removably fixed, to the drill 1000, battery 1006, or container 1008. Each drill bit holder may be mounted in a horizontal orientation, a vertical orientation, or at an angled orientation. When a job is being undertaken with drill or driver, a quick chuck can be used so that the required drills and/or bits are stored conveniently outside container so that they may be quickly exchanged between one of the bit holders, such as bit holder 1012, and chuck 1002.

Each drill bit holder 1012, 1014, 1018, and 1020 may be magnetized or employ one or more magnets as shown for drill bit holder 1020 in FIG. 10A. Drill bit holder 1022 includes molding 1026, and bottom housing 1022 with opening 1024. Shown dotted is embedded magnet 1028. Such a magnetic holder design gives secure storage of bits or drills, or the like, with minimal cost and maximum accessibility. The inside of enclosure 1020 may be open or closed at 1026. The front of drill bit holder 1020 can also be open or partially open at front portion 1022.

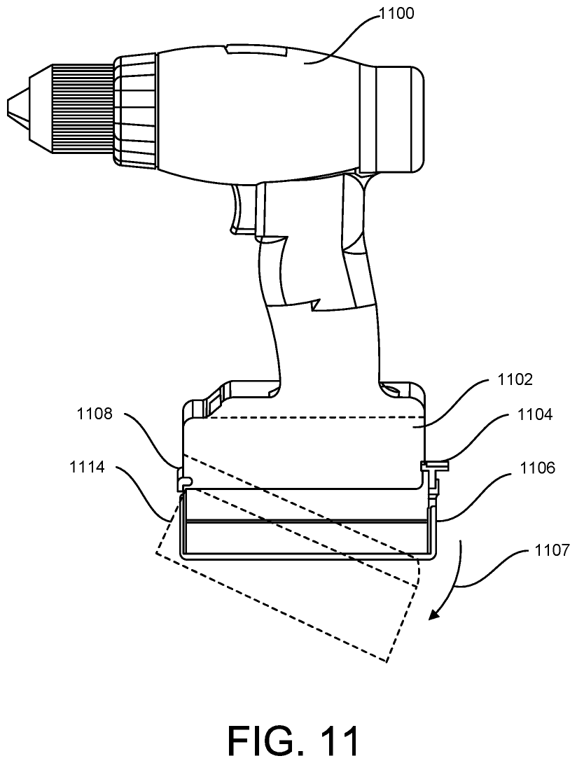

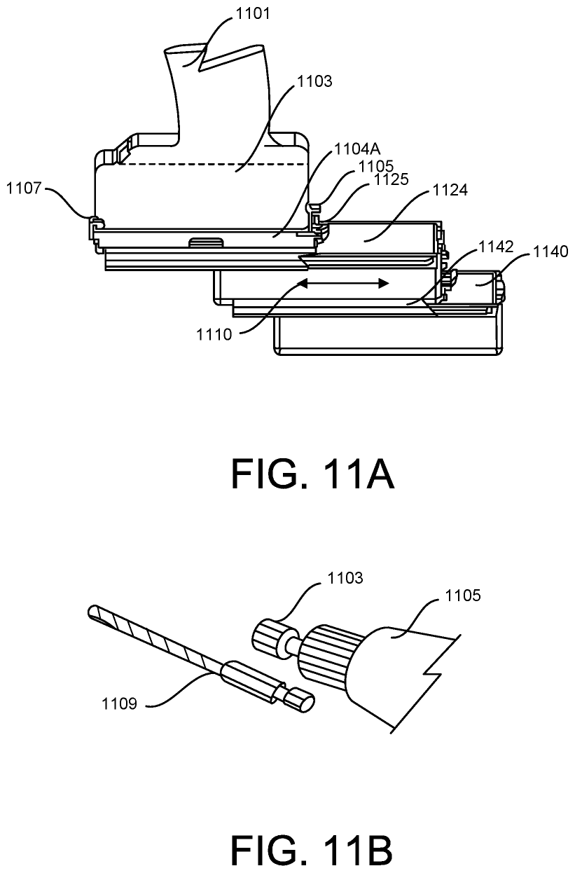

FIG. 11 shows a cordless drill 1100 with battery 1102 attached, similar to previous examples. Attached to the bottom of battery 1102, shown in section for clarity, is container 1106, used to store drills, bits and other associated accessories. A first edge of the container 1106 connects to bottom of battery 1102 in a tongue and groove connection at 1108. As pictured, the first edge is an upper left edge of the container 1106. The tongue and groove connection forms a hinge for the container 1106, which rotates as shown by arrow 1107 to snap onto the bottom of battery 1102 and latch into place at latch 1104.

As shown, container 1106 does not have a lid. In other embodiments, such as the embodiment of FIG. 11A, a bottom container may have a lid that snaps on (or otherwise connects) to battery or drill/driver. FIG. 11A shows a sectioned lower portion of a cordless drill 1101 with a battery 1103 and a bottom container 1124. Bottom container 1124 has a lid 1104A. Lid 1104A attaches (snaps on or otherwise connects) to battery 1103 via a tongue and groove connection 1107 and a latch connection 1105. Lid 1104A could also connect to battery 1103 by hook and loop, or by another means of fastening. Container 1124 slides on rails to open and close per arrow 1110. Container 1124 includes snap fastener 1125 for closing and opening container 1124.

A second container 1140 may be attached to container 1124 below container 1124. The second container 1140 opens and closes, and slides independently, of container 1124. Different bits or drill/driver pieces may be held in container 1124 and 1140 so as to be more readily available with a minimum of searching. While FIG. 11A illustrates a stack of two containers attached to the bottom of battery 1103, other implementations may include a stack of 1, 2, 3, or more bottom containers.

FIG. 11B illustrates a portion of a cordless driver 1104 with quick attach chuck 1103. Quick attach chuck 1103 are designed for attaching and detaching a variety of driver bits, such as driver bit 1109 with a hexagonal base. During operation, a tradesman or handyman may replace a first bit with a second bit by removing the first bit from chuck 1103 selecting a second bit from a container 1106, 1124, or 1140, and attaching the selected second bit to chuck 1103.

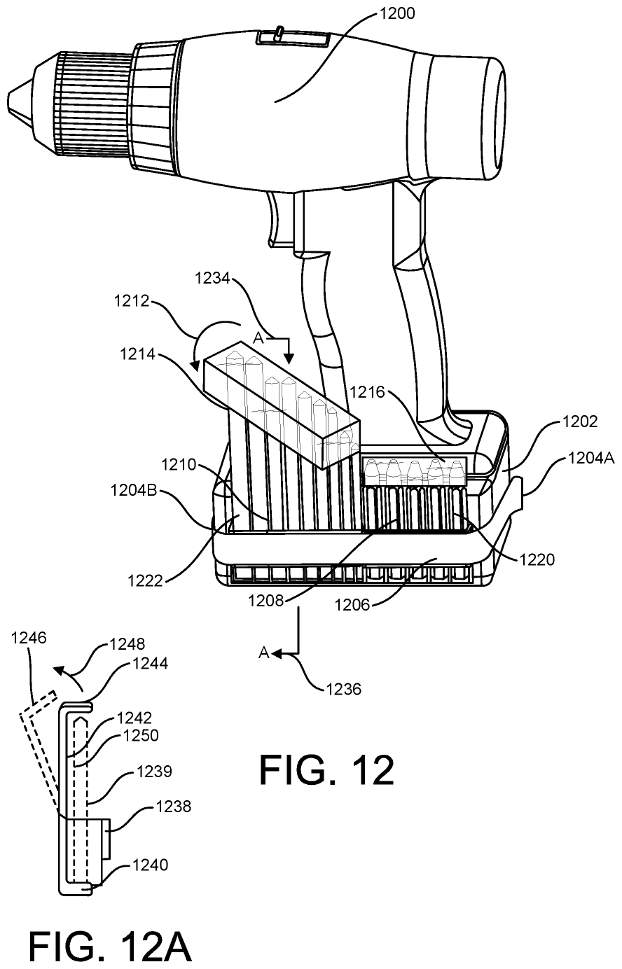

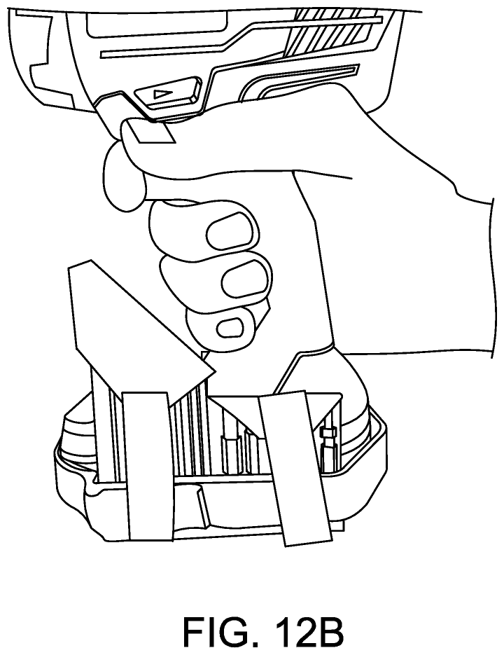

FIG. 12 shows a drill or driver 1200, with battery 1202 and a container or holder 1206. A combination of bits 1220 and drills 1222 is shown held in holder 1206. The holder assembly 1206 may be attached to either battery 1202 or to drill 1200 by hook and loop attachments 1204A and 1204B. Various embodiments may use other attachment mechanisms. Cover 1214 covers drills 1222, and cover 1216 covers bits 1220. These covers 1214 and 1216 may be a combined, single cover, or be separate covers. Covers 1214 and 1216 may be held closed using hook and loop pieces 1208 and 1210. Various embodiments use one hook and loop piece. Covers 1214 and 1216 are optional parts used to firmly secure bits 1220 and/or drills 1222 during use. Covers 1214 and 1216 may be formed of fabric or flexible plastic. Different embodiments may use other forms of closure of covers, such as snaps, press studs, hooks, or the like.

FIG. 12A shows an alternate construction 1230 where a one-piece (or more) flexible molding is used. FIG. 12A shows a typical part cross section of AA, the position shown at 1234 and 1236 of FIG. 12. FIG. 12A shows holder of flexible plastic or rubber etc. 1230 with enclosure or partial enclosure 1238 and bottom stop 1240. A back is shown at 1242 with top 1244. The top portion 1244 of the one-piece flexible molding 1230 retains a drill bit 1250, shown dotted. The top portion 1244 of the one-piece flexible molding is shown at its relaxed position. Drill and/or driver bits 1250 are removed by flexing the top portion 1244 as shown by the dotted position 1246 and arrow 1248, to provide a secure but easy and quick system to remove and fit drills or bits being used for a specific job, while securely retaining the remaining drills and/or bits.

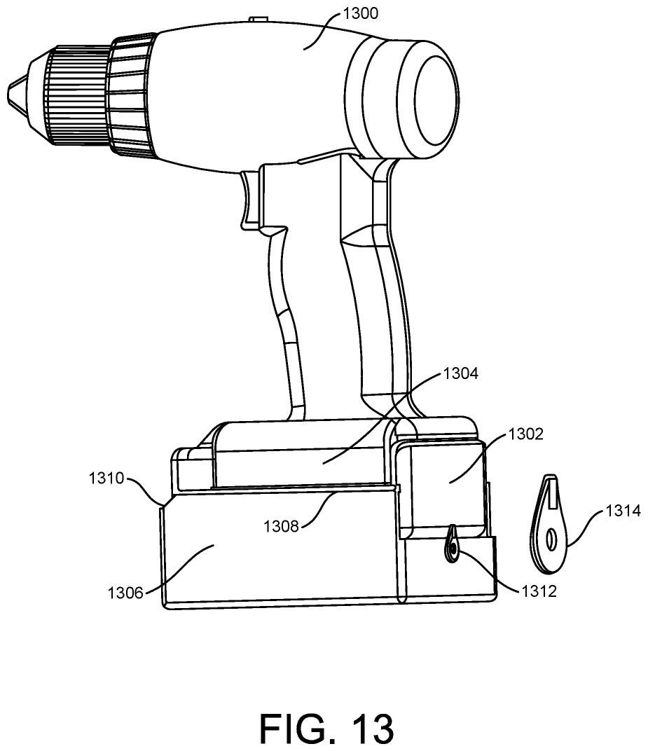

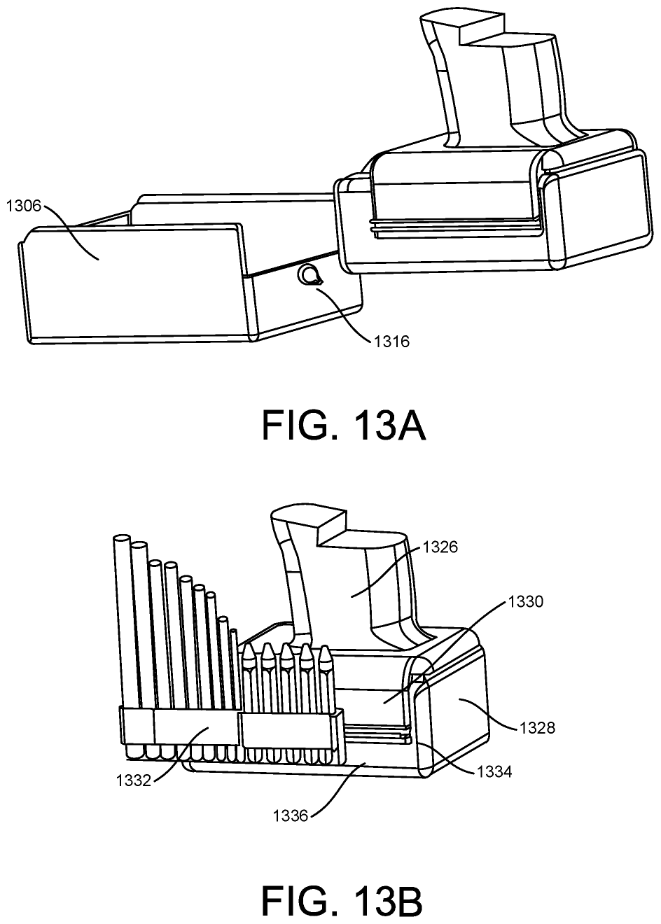

FIG. 13 shows a drill or driver 1300, with battery 1302. The lower portion of drill/driver 1300 has an extended side portion 1304, which can be built to directly attach a container 1306. Container 1306 slides on tongue and groove type rails 1308. Container 1306 has a stop at 1310 and a rotating cam lock 1312, shown enlarged and in a closed position at 1314.

FIG. 13A shows container 1306 opened with cam lock 1312 rotated to the unlock position 1316.

FIG. 13B shows the lower drill/driver portion 1326 with battery 1328. Drill 1326 is shown with sides 1330. Drill bit holder assembly 1332 is attached directly to side 1330 of drill 1300, rather than batter 1328. Drill bit assembly 1332 is mounted on drill 1326 side via tongue and groove 1334. In this and other examples herein, the tongue and groove may be interlocking. Holder 1332 can lock in groove 1310 by friction, jamming or with indents. Although groove 1334 is shown horizontal, a vertical groove shown at 1336 could also be used. Other angled grooves may also be used. Other forms of attachments may be employed, including hook and loop, or the like.

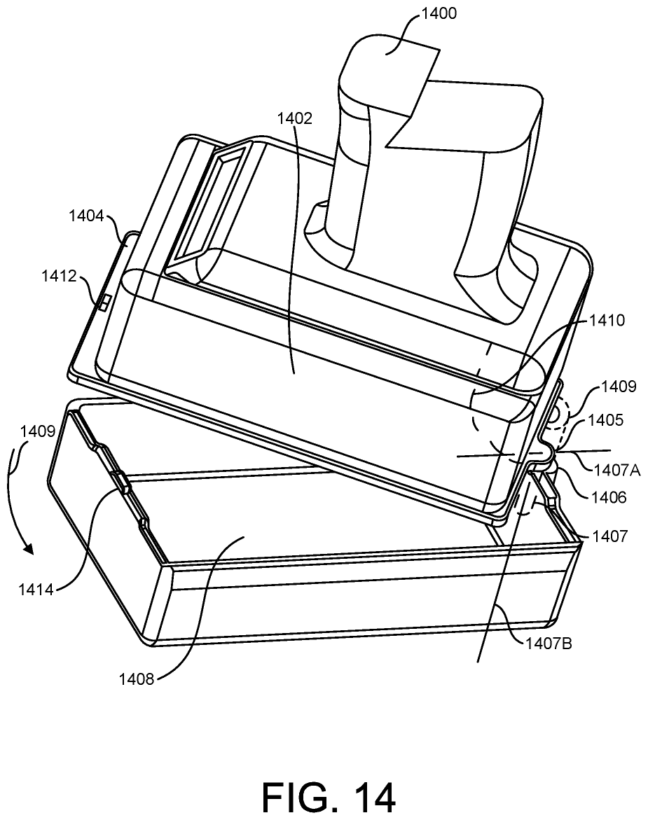

FIG. 14 shows an alternate arrangement of a container for attachment to a cordless drill or driver, for storage of drill and/or driver bits, and other pieces. A bottom section of a cordless drill 1400 is shown with battery 1402. Attached to battery 1402 is lid 1404 of a container 1408. Lid 1404 can be removably attached to battery 1402 by any attachment means, such as hook and loop, snap on, or another previously described fastening mechanism. Lid 1404 has a downward constructed pin 1407 attached to the lid flange 1405. Container 1408 has a boss 1406 with a hole through which pin 1407 of lid 1404, shown dotted, extends. Drawer 1408 is opened and closed by rotating about axis 1407B of pin 1407. Container 1408 has boss 1414, such that when closed, the boss 1414 of container 1408 engages slot 1412 of lid 1404 in order to retain container 1408 in a closed position. The rotating pin and hole could be placed at either end or side of the drill 1500. In various embodiments, the pin and boss 106 could protrude upwards rather than downwards as shown dotted at 1406.

In FIG. 14, the boss 1406 and hole are oriented upwards from lid 1404, as shown dotted at 1409. The protrusion and hole 1409 may be an integral part of battery 1402 rather than be removable, in which case a vertical pin could be arranged to snap into boss and hole 1409.

In various embodiments, boss and hole 1409 could be made integral with drill/driver 1400, as shown by dotted line 1410, and be independent of battery 1403

The implementations presented above are examples, and other variations are possible. Various holders or containers can be mounted on the battery or directly to the drill or even built into the drill itself.

The connection systems shown are not meant to limit the connections of holder or containers. All of the described holders or containers could be attached via special brackets or features to facilitate connection to the drill itself. Similarly, batteries could be designed to facilitate a connection of holders or containers.

Also, the foregoing is not meant to limit the type of holder or container for the quick attachment of multiple drills or bits.

The connection system to the battery should be able to be quickly and readily attached or detached. The one or more drill and/or driver bits can be stored in containers loosely as well as in organizing holders as shown. More than one holder or container may be attached to the same drill.

When a feature or element is herein referred to as being “on” another feature or element, it can be directly on the other feature or element or intervening features and/or elements may also be present. In contrast, when a feature or element is referred to as being “directly on” another feature or element, there are no intervening features or elements present. It will also be understood that, when a feature or element is referred to as being “connected”, “attached” or “coupled” to another feature or element, it can be directly connected, attached or coupled to the other feature or element or intervening features or elements may be present. In contrast, when a feature or element is referred to as being “directly connected”, “directly attached” or “directly coupled” to another feature or element, there are no intervening features or elements present.

Although described or shown with respect to one embodiment, the features and elements so described or shown can apply to other embodiments. It will also be appreciated by those of skill in the art that references to a structure or feature that is disposed “adjacent” another feature may have portions that overlap or underlie the adjacent feature.

Terminology used herein is for the purpose of describing particular embodiments and implementations only and is not intended to be limiting. For example, as used herein, the singular forms “a”, “an” and “the” are intended to include the plural forms as well, unless the context clearly indicates otherwise. It will be further understood that the terms “comprises” and/or “comprising,” when used in this specification, specify the presence of stated features, steps, operations, elements, and/or components, but do not preclude the presence or addition of one or more other features, steps, operations, elements, components, and/or groups thereof. As used herein, the term “and/or” includes any and all combinations of one or more of the associated listed items and may be abbreviated as “/”.

In the descriptions above and in the claims, phrases such as “at least one of” or “one or more of” may occur followed by a conjunctive list of elements or features. The term “and/or” may also occur in a list of two or more elements or features. Unless otherwise implicitly or explicitly contradicted by the context in which it used, such a phrase is intended to mean any of the listed elements or features individually or any of the recited elements or features in combination with any of the other recited elements or features. For example, the phrases “at least one of A and B;” “one or more of A and B;” and “A and/or B” are each intended to mean “A alone, B alone, or A and B together.” A similar interpretation is also intended for lists including three or more items. For example, the phrases “at least one of A, B, and C;” “one or more of A, B, and C;” and “A, B, and/or C” are each intended to mean “A alone, B alone, C alone, A and B together, A and C together, B and C together, or A and B and C together.” Use of the term “based on,” above and in the claims is intended to mean, “based at least in part on,” such that an unrecited feature or element is also permissible.

Spatially relative terms, such as “under”, “below”, “lower”, “over”, “upper” and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if a device in the figures is inverted, elements described as “under” or “beneath” other elements or features would then be oriented “over” the other elements or features. Thus, the exemplary term “under” can encompass both an orientation of over and under. The device may be otherwise oriented (rotated 90 degrees or at other orientations) and the spatially relative descriptors used herein interpreted accordingly. Similarly, the terms “upwardly”, “downwardly”, “vertical”, “horizontal” and the like are used herein for the purpose of explanation only unless specifically indicated otherwise.

Although the terms “first” and “second” may be used herein to describe various features/elements (including steps), these features/elements should not be limited by these terms, unless the context indicates otherwise. These terms may be used to distinguish one feature/element from another feature/element. Thus, a first feature/element discussed below could be termed a second feature/element, and similarly, a second feature/element discussed below could be termed a first feature/element without departing from the teachings provided herein.

Although various illustrative embodiments are described above, any of a number of changes may be made to various embodiments without departing from the teachings herein. For example, the order in which various described method steps are performed may often be changed in alternative embodiments, and in other alternative embodiments, one or more method steps may be skipped altogether. Further, for example, the logic flows depicted in the accompanying figures and described herein do not require the particular order shown, or sequential order, to achieve desirable results. Optional features of various device and system embodiments may be included in some embodiments and not in others. Therefore, the foregoing description is provided primarily for exemplary purposes and should not be interpreted to limit the scope of the claims.

The examples and illustrations included herein show, by way of illustration and not of limitation, specific embodiments in which the subject matter may be practiced. As mentioned, other embodiments may be utilized and derived there from, such that structural and logical substitutions and changes may be made without departing from the scope of this disclosure. Such embodiments of the inventive subject matter may be referred to herein individually or collectively by the term “invention” merely for convenience and without intending to voluntarily limit the scope of this application to any single invention or inventive concept, if more than one is, in fact, disclosed. Thus, although specific embodiments have been illustrated and described herein, any arrangement calculated to achieve the same purpose may be substituted for the specific embodiments shown. This disclosure is intended to cover any and all adaptations or variations of various embodiments. Combinations of the above embodiments, and other embodiments not specifically described herein, will be apparent to those of skill in the art upon reviewing the above description.

Additional implementations may be within the scope of the following claims.

What is claimed is:

1. A system comprising:
a container to store at least one of one or more drill and/or driver bits; and
an attachment mechanism adapted to connect the container to a drill, the connection enabling access to at least one of the one or more drill and/or driver bits.

2. The system of claim 1, wherein the system comprises another container.

3. The system of claim 1, wherein the container comprises a drill bit pouch.

4. The system of claim 1, wherein the container comprises a drawer.

5. The system of claim 1, wherein the attachment mechanism is adapted to connect the container to a side of the drill.

6. The system of claim 1, wherein the attachment mechanism is adapted to connect the container to a bottom of the drill.

7. The system of claim 1, wherein the drill comprises a handle, and wherein the attachment mechanism is adapted to connect the container to the handle.

8. The system of claim 1, wherein the drill comprises a drill barrel, and wherein the attachment mechanism is adapted to connect the container to the drill barrel.

9. The system of claim 1, wherein the container comprises hook attachments for engagement of a loop strip.

10. The system of claim 1, wherein the attachment mechanism comprises at least one hook and loop strip.

11. The system of claim 1, wherein the attachment mechanism comprises a holder strip configured to wrap around at least a portion of at least one of the container and the drill.

12. The system of claim 1, wherein the container comprises a cam lock.

13. The system of claim 1, wherein the attachment mechanism comprises a tongue and a groove, the tongue and the groove configured to interlock.

14. The system of claim 1, wherein the attachment mechanism comprises a bracket.

15. The system of claim 1, wherein the container is attached to a battery.

16. The system of claim 15, wherein the attachment mechanism is adapted to connect the container to the battery.

17. The system of claim 15, wherein the attachment mechanism comprises a holder strip configured to wrap around at least a portion of the battery.
